(19) United States
(12) Patent Application Publication
(10) Pub. No.: US 2023/0418026 A1
(43) Pub. Date: Dec. 28, 2023

(54) Lens Assembly

(71) Applicants: Sintai Optical (Shenzhen) Co., Ltd., ShenZhen City (CN); Asia Optical Co., Inc., Taichung (TW)

(72) Inventors: Yuan-Fan Liang, Taichung (TW); Jia-Sin Chen, Taichung (TW)

(21) Appl. No.: 18/306,282

(22) Filed: Apr. 25, 2023

(30) Foreign Application Priority Data
Jun. 28, 2022 (TW) 111124102

(51) Int. Cl. G02B 9/34; G02B 13/00; H04N 23/53

(52) U.S. Cl. CPC G02B 9/34; H04N 23/53; G02B 13/006; G02B 13/004

(57) ABSTRACT

A lens assembly includes a first lens, a second lens, a third lens, and a cover glass. The first lens is with positive refractive power and includes a convex surface facing an image side. The second lens is a meniscus lens with refractive power. The third lens is with positive refractive power and includes a convex surface facing the image side. The first lens, the second lens, the third lens, and the cover glass are arranged in order from the image side to an object side along a first optical axis.

### BACKGROUND OF THE INVENTION

### Field of the Invention

The present invention relates to a lens assembly, in particular to the lens assembly applied to an electronic viewfinder.

### Description of the Related Art

The field of view of today's electronic viewfinder is mostly less than 30 degrees, which can no longer meet today's requirements. The present invention proposes a lens assembly including a new structure which can increase the field of view, increase the resolution, correct the aberration, and correct the chromatic aberration effectively. When applied to an electronic viewfinder, it can increase the field of view of the electronic viewfinder to about 45 degrees.

### BRIEF SUMMARY OF THE INVENTION

The invention provides a lens assembly to solve the above problems. The lens assembly of the invention is provided with characteristics of an increased field of view, an increased resolution, and still has a good optical performance.

The lens assembly in accordance with an exemplary embodiment of the invention includes a first lens, a second lens, a third lens, and a cover glass. The first lens is with positive refractive power and includes a convex surface facing an image side. The second lens is a meniscus lens with refractive power. The third lens is with positive refractive power and includes a convex surface facing the image side. The first lens, the second lens, the third lens, and the cover glass are arranged in order from the image side to an object side along a first optical axis. The lens assembly satisfies at least one of the following conditions: 0.6<f/TTL<0.8; 0.85<(f+BFL)/TTL<1.2; 0.36<(f−BFL)/TTL<0.55; 1.6<(TTL+BFL)/f<1.95; 0.5<(TTL-BFL)/f<1.15; wherein f is an effective focal length of the lens assembly, TTL is an interval from an image side surface of the first lens to a lighting surface along the first optical axis, and BFL is an interval from an object side surface of the lens closest to the object side to an image side surface of the cover glass along the first optical axis.

In another exemplary embodiment, the lens assembly further includes a fourth lens, wherein the fourth lens is with negative refractive power and includes a concave surface facing the object side.

In yet another exemplary embodiment, the fourth lens is disposed between the third lens and the cover glass.

In another exemplary embodiment, the first lens is a biconvex lens and further includes another convex surface facing the object side.

In yet another exemplary embodiment, wherein the second lens is with negative refractive power and includes a concave surface facing the image side and a convex surface facing the object side; the third lens is a biconvex lens and further includes another convex surface facing the object side; and the fourth lens is a biconcave lens and further includes another concave surface facing the image side.

In another exemplary embodiment, wherein the second lens further includes a convex surface facing the image side and a concave surface facing the object side; the third lens is a meniscus lens and further includes a concave surface facing the object side; and the fourth lens is a meniscus lens and further includes a convex surface facing the image side.

In yet another exemplary embodiment, wherein the third lens and the fourth lens are cemented; the first lens is a single lens instead of a cemented lens; the second lens is a single lens instead of a cemented lens; and an interval is disposed between the first lens and the second lens.

In another exemplary embodiment, the fourth lens further includes an image side surface facing the image side, wherein the image side surface does not include an inflection point; and the concave surface of the fourth lens does not include an inflection point.

In yet another exemplary embodiment, the first lens and the second lens can move \ b along the first optical axis for focusing.

In another exemplary embodiment, the lens assembly further includes a lens group, wherein the lens group is arranged along a second optical axis, and the first optical axis and the second optical axis are not coaxial.

In yet another exemplary embodiment, the lens assembly further includes an image sensor element, wherein the image sensor element is arranged along a second optical axis, and the first optical axis and the second optical axis are not coaxial.

In another exemplary embodiment, the lens assembly further includes a display source disposed between the cover glass and the object side, wherein the position of the display source overlaps with the lighting surface; and the cover glass and the display source are arranged in order from the image side to the object side along the first optical axis.

In yet another exemplary embodiment, the fourth lens is disposed between the second lens and the third lens.

In another exemplary embodiment, the first lens is a meniscus lens and further includes a concave surface facing the object side.

In yet another exemplary embodiment, wherein the second lens is with positive refractive power and includes a convex surface facing the image side and a concave surface facing the object side; the fourth lens is a meniscus lens and further includes a convex surface facing the image side; and the third lens is a biconvex lens and further includes another convex surface facing the object side.

In another exemplary embodiment, wherein the first lens is a single lens instead of a cemented lens; the second lens is a single lens instead of a cemented lens; and an interval is disposed between the first lens and the second lens.

In yet another exemplary embodiment, wherein the convex surface of the third lens does not include an inflection point; and the another convex surface of the third lens does not include an inflection point.

In another exemplary embodiment, the first lens and the second lens can move along the first optical axis for focusing.

In yet another exemplary embodiment, the lens assembly further includes a display source disposed between the cover glass and the object side, wherein the position of the display source overlaps with the lighting surface; and the cover glass and the display source are arranged in order from the image side to the object side along the first optical axis.

In another exemplary embodiment, the first lens, the second lens, the third lens, and the fourth lens can move synchronously along the optical axis for focusing.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of a lens assembly in accordance with a first embodiment of the invention;

FIG. 2 depicts a longitudinal aberration diagram, a field curvature diagram, a distortion diagram, a lateral color diagram, and a modulation transfer function diagram of the lens assembly in accordance with the first embodiment of the invention;

FIG. 3 is a lens layout diagram of a lens assembly in accordance with a second embodiment of the invention;

FIG. 4 depicts a longitudinal aberration diagram, a field curvature diagram, a distortion diagram, a lateral color diagram, and a modulation transfer function diagram of the lens assembly in accordance with the second embodiment of the invention;

FIG. 5 is a lens layout diagram of a lens assembly in accordance with a third embodiment of the invention;

FIG. 6 depicts a longitudinal aberration diagram, a field curvature diagram, a distortion diagram, a lateral color diagram, and a modulation transfer function diagram of the lens assembly in accordance with the third embodiment of the invention; and

FIG. 7 is a lens layout diagram of a lens assembly in accordance with a fourth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, and a cover glass. The first lens is with positive refractive power and includes a convex surface facing an image side. The second lens is a meniscus lens with refractive power. The third lens is with positive refractive power and includes a convex surface facing the image side. The first lens, the second lens, the third lens, and the cover glass are arranged in order from the image side to an object image side along a first optical axis. The lens assembly satisfies at least one of the following conditions: 0.6<f/TTL<0.8; 0.85<(f+BFL)/TTL<1.2; 0.36<(f−BFL)/TTL<0.55; 1.6<(TTL+BFL)/f<1.95; 0.5<(TTL−BFL)/f<1.15; wherein f is an effective focal length of the lens assembly, TTL is an interval from an image side surface of the first lens to a lighting surface along the first optical axis, and BFL is an interval from an object side surface of the lens closest to the object side to an image side surface of the cover glass along the first optical axis.

Referring to Table 1, Table 2, Table 4, Table 5, Table 7, and Table 8, wherein Table 1, Table 4, and Table 7 show optical specification in accordance with a first, second, and third embodiments of the invention, respectively and Table 2, Table and Table 8 show aspheric coefficients of each aspheric lens in Table 1, Table 4, and Table 7, respectively.

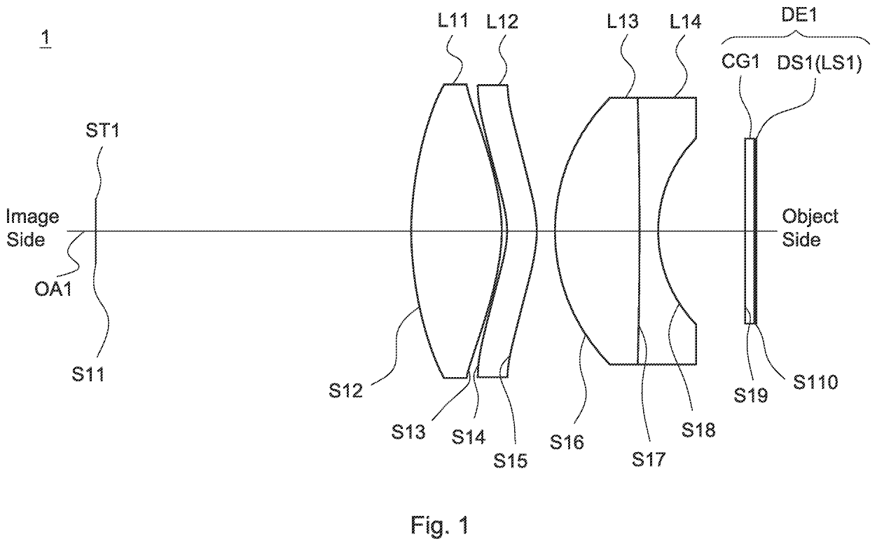

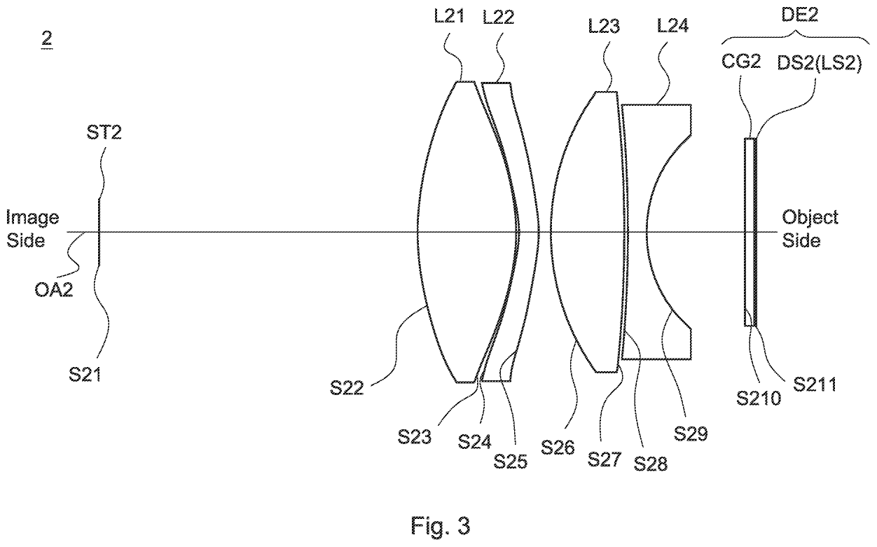

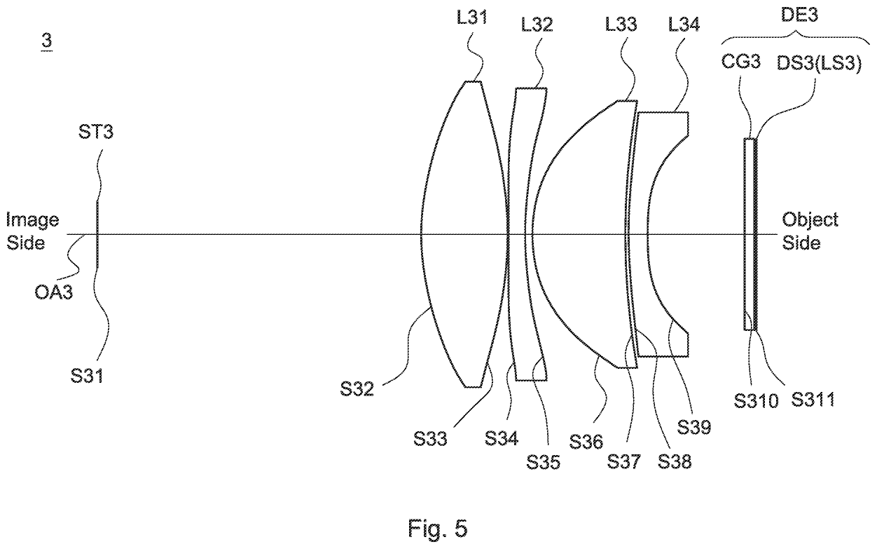

FIG. 1, FIG. 3, and FIG. 5 are lens layout diagrams of the lens assemblies in accordance with the first, second, and third embodiments of the invention, respectively.

The first lenses L11, L21, L31 are biconvex lenses with positive refractive power and made of glass material, wherein the image side surfaces S12, S22, S32 are convex surfaces, the object side surfaces S13, S23, S33 are convex surfaces, and both of the image side surfaces S12, S22, S32 and object side surfaces S13, S23, S33 are aspheric surfaces.

The second lenses L12, L22, L32 are meniscus lenses with negative refractive power and made of glass material, wherein both of the image side surfaces S14, S24, S34 and object side surfaces S15, S25, S35 are aspheric surfaces.

The third lenses L13, L23, L33 are with positive refractive power and made of glass material, wherein the image side surfaces S16, S26, S36 are convex surfaces.

The fourth lenses L14, L24, L34 are with negative refractive power and made of glass material, wherein the object side surfaces S18, S29, S39 are concave surfaces.

In addition, the lens assemblies 1, 2, and 3 satisfy at least one of the following conditions:

0.6<f/TTL<0.8; (1)

0.85<(f+BFL)/TTL<1.2; (2)

0.36<(f−BFL)/TTL<0.55; (3)

1.6<(TTL+BFL)/f<1.95; (4)

0.5<(TTL−BFL)/f<1.15; (5)
wherein: TTL is an interval from the image side surfaces S12, S22, S32 of the first lenses L11, L21, L31 to the lighting surface LS1, LS2, LS3 along the first optical axes OA1, OA2, OA3 for the first to third embodiments; f is an effective focal length of the lens assemblies 1, 2, 3 for the first to third embodiments; and BFL is an interval from the object side surfaces S18, S29, S39 of the fourth lenses (closest to the object side) L14, L24, L34 to the image side surfaces S19, S210, S310 of the cover glasses CG1, CG2, CG3 along the first optical axes OA1, OA2, OA3 for the first to third embodiments. With the lens assemblies 1, 2, 3 satisfying at least one of the above conditions (1)-(5), the field of view can be effectively increased, the resolution can be effectively increased, the aberration can be effectively corrected, and the chromatic aberration can be effectively corrected.

A detailed description of a lens assembly in accordance with a first embodiment of the invention is as follows. Referring to FIG. 1, the lens assembly 1 includes a stop ST1, a first lens L11, a second lens L12, a third lens L13, a fourth lens L14, and a display element DE1, all of which are arranged in order from an image side to an object side along a first optical axis OA1. The first lens L11 and the second lens L12 can move synchronously along the first optical axis OA1 for focusing. The interval from the object side surface S15 of the second lens L12 to the image side surface S16 of the third lens L13 ranges from 0.4 mm to 2 mm and the effective focal length of the lens assembly 1 ranges from 12.359 mm to 12.173 mm, when the first lens L11 and the second lens L12 move synchronously along the first optical axis OA1 for focusing. The display element DE1 includes a cover glass CG1 and a display source DS1, both of which are arranged in order from the image side to the object side along the first optical axis OA1. The display source DS1 coincides with a lighting surface LS1. When in use, the human eye is located at the stop ST1 and the image of the display source DS1 can be seen.

According to the foregoing, wherein: the image side surface S14 is a concave surface and the object side surface S15 is a convex surface for the second lens L12; the third lens L13 is a biconvex lens, wherein the object side surface S17 is a convex surface and both of the image side surface S16 and object side surface S17 are spherical surfaces; the fourth lens L14 is a biconcave lens, wherein the image side surface S17 is a concave surface and both of the image side surface S17 and object side surface S18 are spherical surfaces; the third lens L13 is cemented with the fourth lens L14; and both of the image side surface S19 and object side surface S110 of the cover glass CG1 are plane surfaces.

With the above design of the lenses, stop ST1, and at least one of the conditions (1)-(5) satisfied, the lens assembly 1 can have an effective increased field of view, an effective increased resolution, an effective corrected aberration, and an effective corrected chromatic aberration.

Table 1 shows the optical specification of the lens assembly 1 in FIG. 1.

TABLE 1
Effective Focal Length = 12.291 mm F−number = 3.51
Total Lens Length = 18.629 mm Field of View = 45 degrees

| Surface | Radius of | Thickness | | | Effective Focal | |
|---|---|---|---|---|---|---|
| Number | Curvature (mm) | (mm) | Nd | Vd | Length (mm) | Remark |
| S11 | ∞ | 17 | | | | ST1 |
| S12 | 16.74633 | 4.889982 | 1.535 | 56.12 | 10.844 | L11 |
| S13 | −7.977962 | 0.2868073 | | | | |
| S14 | −4.784463 | 1.599714 | 1.671 | 19.24 | −50.787 | L12 |
| S15 | −6.312899 | 0.97603 | | | | |
| S16 | 10.18435 | 4.571457 | 1.883 | 40.81 | 11.186 | L13 |
| S17 | −258.3849 | 1 | 1.946 | 17.94 | −7.365 | L14 |
| S18 | 7.173218 | 4.704623 | | | | |
| S19 | ∞ | 0.5 | 1.517 | 64.17 | | CG1 |
| S110 | ∞ | 0.1 | | | | |

The aspheric surface sag z of each aspheric lens in table 1 can be calculated by the following formula:

z=ch²/{1+[1−(k+1)c²h²]^{1/2}}+Ah⁴+Bh⁶+Ch⁸+Dh¹⁰

where c is curvature, h is the vertical distance from the lens surface to the optical axis, k is conic constant and A, B, C, and D are aspheric coefficients.

In the first embodiment, the conic constant k and the aspheric coefficients A, B, C, D of each aspheric lens are shown in Table 2.

TABLE 2

| Surface | | | | | |
|---|---|---|---|---|---|
| Number | k | A | B | C | D |
| S12 | 2.563024 | −0.000408352 | 1.01E−05 | −1.56E−07 | 7.52E−10 |
| S13 | −25.62701 | −0.000853694 | 2.53E−05 | −3.53E−07 | 2.04E−09 |
| S14 | −7.837845 | 0.000894813 | −3.30E−05 | 5.44E−07 | −3.07E−09 |
| S15 | 0.001280197 | −4.50E−05 | 6.99E−07 | −3.79E−09 | 0.001280197 |

Table 3 shows the parameters and condition values for conditions (1)-(5) in accordance with the first embodiment of the invention. It can be seen from Table 3 that the lens assembly 1 of the first embodiment satisfies the conditions (1)-(5).

TABLE 3

| | | | | | |
|---|---|---|---|---|---|
| BFL | 4.70 mm | | | | |
| f/TTL | 0.66 | (f + BFL)/TTL | 0.91 | (f − BFL)/TTL | 0.41 |
| (TTL + | 1.90 | (TTL − BFL)/f | 1.13 | | |
| BFL)/f | | | | | |

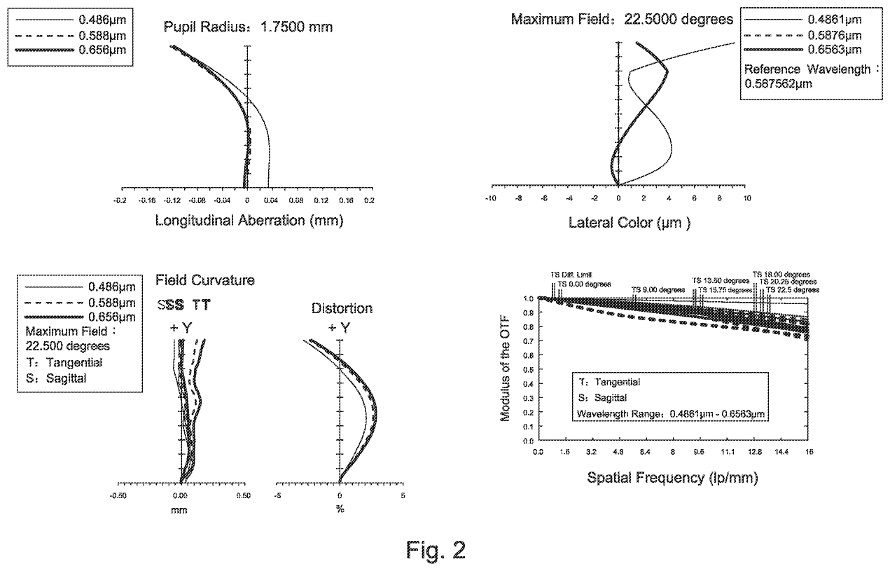

In addition, the lens assembly 1 of the first embodiment can meet the requirements of optical performance as seen in FIG. 2. It can be seen from FIG. 2 that the longitudinal aberration in the lens assembly 1 of the first embodiment ranges from −0.14 mm to 0.04 mm, the field curvature of tangential direction and sagittal direction in the lens assembly 1 of the first embodiment ranges from −0.1 mm to 0.2 mm, the distortion in the lens assembly 1 of the first embodiment ranges from −3% to 3%, the lateral color in the lens assembly 1 of the first embodiment ranges from −1 μm to 10 μm, and the modulation transfer function of tangential direction and sagittal direction in the lens assembly 1 of the first embodiment ranges from 0.70 to 1.0. It is obvious that the longitudinal aberration, the field curvature, the distortion, and the lateral color of the lens assembly 1 of the first embodiment can be corrected effectively, the image resolution can meet the requirements. Therefore, the lens assembly 1 of the first embodiment is capable of good optical performance.

Referring to FIG. 3, the lens assembly 2 includes a stop ST2, a first lens L21, a second lens L22, a third lens L23, a fourth lens L24, and a display element DE2, all of which are arranged in order from an image side to an object side along a first optical axis OA2. The first lens L21 and the second lens L22 can move synchronously along the first optical axis OA2 for focusing. The interval from the object side surface S25 of the second lens L22 to the image side surface S26 of the third lens L23 ranges from 0.06 mm to 1.636 mm and the effective focal length of the lens assembly 2 ranges from 12.298 mm to 12.286 mm, when the first lens L21 and the second lens L22 move synchronously along the first optical axis OA2 for focusing. The display element DE2 includes a cover glass CG2 and a display source DS2, both of which are arranged in order from the image side to the object side along the first optical axis OA2. The display source DS2 coincides with the lighting surface LS2. When in use, the human eye is located at the stop ST2 and the image of the display source DS2 can be seen.

According to the foregoing, wherein: the image side surface S24 is a concave surface and the object side surface S25 is a convex surface for the second lens L22; the third lens L23 is a biconvex lens, wherein the object side surface S27 is a convex surface and both of the image side surface S26 and object side surface S27 are spherical surfaces; the fourth lens L24 is a biconcave lens, wherein the image side surface S28 is a concave surface and both of the image side surface S28 and object side surface S29 are aspheric surfaces; and both of the image side surface S210 and object side surface S211 of the cover glass CG2 are plane surfaces.

With the above design of the lenses, stop ST2, and at least one of the conditions (1)-(5) satisfied, the lens assembly 2 can have an effective increased field of view, an effective increased resolution, an effective corrected aberration, and an effective corrected chromatic aberration.

Table 4 shows the optical specification of the lens assembly 2 in FIG. 3.

TABLE 4
Effective Focal Length = 12.294 mm F-number = 3.51
Total Lens Length = 18.085 mm Field of View = 45 degrees

| Surface | Radius of | Thickness | | | Effective Focal | |
|---|---|---|---|---|---|---|
| Number | Curvature (mm) | (mm) | Nd | Vd | Length (mm) | Remark |
| S21 | ∞ | 17 | | | | ST2 |
| S22 | 13.65685 | 5.264703 | 1.535 | 56.12 | 11.508 | L21 |
| S23 | −9.711191 | 0.1532194 | | | | |
| S24 | −4.891997 | 1.054225 | 1.671 | 19.24 | −54.224 | L22 |
| S25 | −6.140668 | 0.6371875 | | | | |
| S26 | 12.73671 | 3.932507 | 1.946 | 17.94 | 12.532 | L23 |
| S27 | −72.15744 | 0.1895589 | | | | |
| S28 | −76.96055 | 1 | 1.671 | 19.24 | −9.885 | L24 |
| S29 | 7.300493 | 5.253659 | | | | |
| S210 | ∞ | 0.5 | 1.517 | 64.17 | | CG2 |
| S211 | ∞ | 0.1 | | | | |

The definition of aspheric surface sag z of each aspheric lens in table 4 is the same as that of in Table 1, and is not described here again.

In the second embodiment, the conic constant k and the aspheric coefficients A, B, C, D of each aspheric lens are shown in Table 5.

TABLE 5

| Surface | | | | | |
|---|---|---|---|---|---|
| Number | k | A | B | C | D |
| S22 | 1.073266 | −5.08E−04 | 1.32E−05 | −2.17E−07 | 1.20E−09 |
| S23 | −22.04647 | −8.16E−04 | 1.63E−05 | −1.46E−07 | 6.04E−10 |
| S24 | −16.70537 | 3.20E−04 | −2.87E−05 | 5.75E−07 | −3.44E−09 |
| S25 | −25.96512 | 2.29E−04 | −1.91E−05 | 3.52E−07 | −1.87E−09 |
| S28 | 0 | −9.46E−06 | 0 | 0 | 0 |
| S29 | −0.1649402 | 0.000424991 | 0 | 0 | 0 |

Table 6 shows the parameters and condition values for conditions (1)-(5) in accordance with the second embodiment of the invention. It can be seen from Table 6 that the lens assembly 2 of the second embodiment satisfies the conditions (1)-(5).

TABLE 6

| | | | | | |
|---|---|---|---|---|---|
| BFL | 5.25 mm | | | | |
| f/TTL | 0.68 | (f + BFL)/TTL | 0.97 | (f − BFL)/TTL | 0.39 |
| (TTL + | 1.90 | (TTL − BFL)/f | 1.04 | | |
| BFL)/f | | | | | |

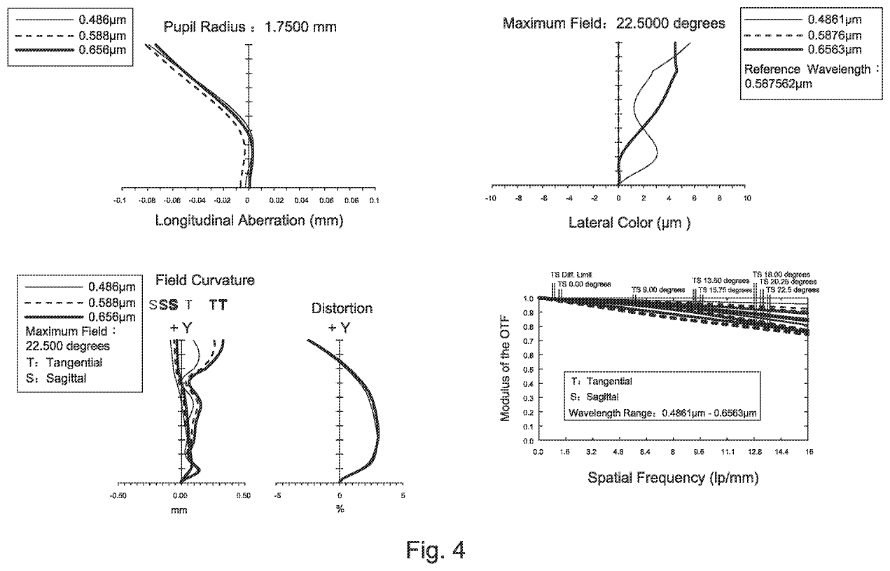

In addition, the lens assembly 2 of the second embodiment can meet the requirements of optical performance as seen in FIG. 4. It can be seen from FIG. 4 that the longitudinal aberration in the lens assembly 2 of the second embodiment ranges from −0.09 mm to 0.01 mm, the field curvature of tangential direction and sagittal direction in the lens assembly 2 of the second embodiment ranges from −0.1 mm to mm, the distortion in the lens assembly 2 of the second embodiment ranges from −3% to 4%, the lateral color in the lens assembly 2 of the second embodiment ranges from 0 μm to 6 μm, and the modulation transfer function of tangential direction and sagittal direction in the lens assembly 2 of the second embodiment ranges from 0.75 to 1.0. It is obvious that the longitudinal aberration, the field curvature, the distortion, and the lateral color of the lens assembly 2 of the second embodiment can be corrected effectively, the image resolution can meet the requirements. Therefore, the lens assembly 2 of the second embodiment is capable of good optical performance.

Referring to FIG. 5, the lens assembly 3 includes a stop ST3, a first lens L31, a second lens L32, a third lens L33, a fourth lens L34, and a display element DE3, all of which are arranged in order from an image side to an object side along a first optical axis OA3. The first lens L31 and the second lens L32 can move synchronously along the first optical axis OA3 for focusing. The interval from the object side surface S35 of the second lens L32 to the image side surface S36 of the third lens L33 ranges from 0.06 mm to 1.7 mm and the effective focal length of the lens assembly 3 ranges from 12.198 mm to 12.677 mm, when the first lens L31 and the second lens L32 move synchronously along the first optical axis OA3 for focusing. The display element DE3 includes a cover glass CG3 and a display source DS3, both of which are arranged in order from the image side to the object side along the first optical axis OA3. The display source DS3 coincides with the lighting surface LS3. When in use, the human eye is located at the stop ST3 and the image of the display source DS3 can be seen.

According to the foregoing, wherein: the image side surface S34 is a convex surface and the object side surface S35 is a concave surface for the second lens L32; the third lens L33 is a meniscus lens, wherein the object side surface S37 is a concave surface and both of the image side surface S36 and object side surface S37 are aspheric surfaces; the fourth lens L34 is a meniscus lens, wherein the image side surface S38 is a convex surface and both of the image side surface S38 and object side surface S39 are aspheric surfaces; and both of the image side surface S310 and object side surface S311 of the cover glass CG3 are plane surfaces.

With the above design of the lenses, stop ST3, and at least one of the conditions (1)-(5) satisfied, the lens assembly 3 can have an effective increased field of view, an effective increased resolution, an effective corrected aberration, and an effective corrected chromatic aberration.

Table 7 shows the optical specification of the lens assembly 3 in FIG. 5.

TABLE 7
Effective Focal Length = 12.290 mm F-number = 3.51
Total Lens Length = 17.485 mm Field of View = 45 degrees

| Surface | Radius of | Thickness | | | Effective Focal | |
|---|---|---|---|---|---|---|
| Number | Curvature (mm) | (mm) | Nd | Vd | Length (mm) | Remark |
| S31 | ∞ | 17 | | | | ST3 |
| S32 | 11.71644 | 4.536425 | 1.535 | 56.12 | 14.446 | L31 |
| S33 | −19.6658 | 0.04641343 | | | | |
| S34 | 359.1218 | 0.8715562 | 1.671 | 19.24 | −26.53 | L32 |
| S35 | 16.95252 | 0.3855117 | | | | |
| S36 | 8.423738 | 4.872253 | 1.535 | 56.12 | 19.052 | L33 |
| S37 | 38.66822 | 0.1729799 | | | | |
| S38 | 25.62293 | 1 | 1.671 | 19.24 | −199.547 | L34 |
| S39 | 21.17178 | 5.000064 | | | | |
| S310 | ∞ | 0.5 | 1.517 | 64.17 | | CG3 |
| S311 | ∞ | 0.1 | | | | |

The definition of aspheric surface sag z of each aspheric lens in table 7 is the same as that of in Table 1, and is not described here again.

In the third embodiment, the conic constant k and the aspheric coefficients A, B, C, D of each aspheric lens are shown in Table 8.

TABLE 8

| Surface | | | | | |
|---|---|---|---|---|---|
| Number | k | A | B | C | D |
| S32 | 0.4481503 | −6.73E−04 | 1.48E−05 | −2.03E−07 | 1.03E−09 |
| S33 | −44.03349 | −5.64E−04 | 1.36E−05 | −1.65E−07 | 8.78E−10 |
| S34 | 0 | −2.48E−04 | 2.03E−05 | −3.43E−07 | 1.65E−09 |
| S35 | −27.97927 | −2.55E−04 | 2.63E−05 | −5.71E−07 | 3.62E−09 |
| S36 | −0.9845058 | 0.000884 | −4.79E−06 | 0 | 0 |
| S37 | −3.251622 | 0 | 0 | 0 | 0 |
| S38 | −53.46959 | 0 | 0 | 0 | 0 |
| S39 | 10.98727 | 0.0027 | −3.41E−05 | 0 | 0 |

Table 9 shows the parameters and condition values for conditions (1)-(5) in accordance with the third embodiment of the invention. It can be seen from Table 9 that the lens assembly 3 of the third embodiment satisfies the conditions (1)-(5).

TABLE 9

| | | | | | |
|---|---|---|---|---|---|
| BFL | 5.01 mm | | | | |
| f/TTL | 0.70 | (f + BFL)/TTL | 0.99 | (f − BFL)/TTL | 0.42 |
| (TTL + | 1.83 | (TTL − BFL)/f | 1.02 | | |
| BFL)/f | | | | | |

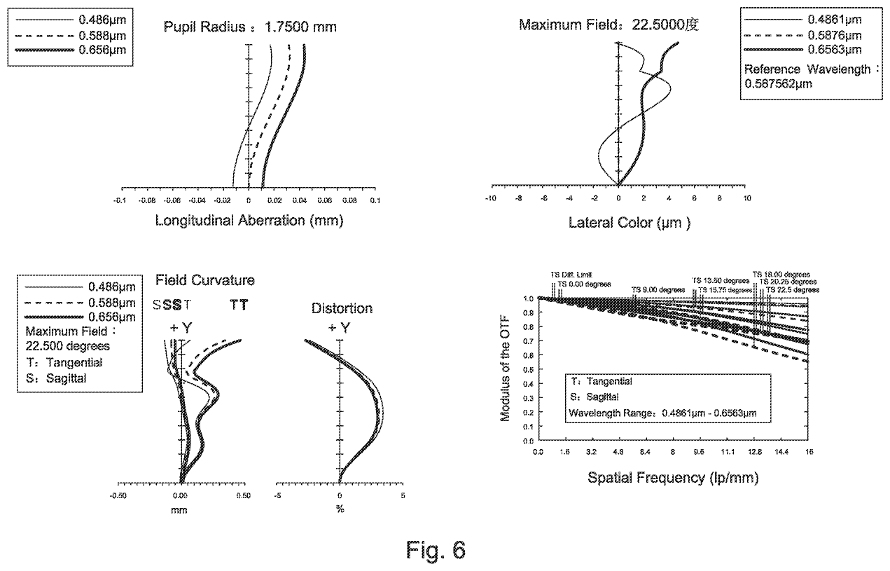

In addition, the lens assembly 3 of the third embodiment can meet the requirements of optical performance as seen in FIG. 6. It can be seen from FIG. 6 that the longitudinal aberration in the lens assembly 3 of the third embodiment ranges from −0.02 mm to 0.05 mm, the field curvature of tangential direction and sagittal direction in the lens assembly 3 of the third embodiment ranges from −0.2 mm to 0.5 mm, the distortion in the lens assembly 3 of the third embodiment ranges from −3% to 4%, the lateral color in the lens assembly 3 of the third embodiment ranges from −2 μm to 5 μm, and the modulation transfer function of tangential direction and sagittal direction in the lens assembly 3 of the third embodiment ranges from 0.56 to 1.0. It is obvious that the longitudinal aberration, the field curvature, the distortion, and the lateral color of the lens assembly 3 of the third embodiment can be corrected effectively, the image resolution can meet the requirements. Therefore, the lens assembly 3 of the third embodiment is capable of good optical performance.

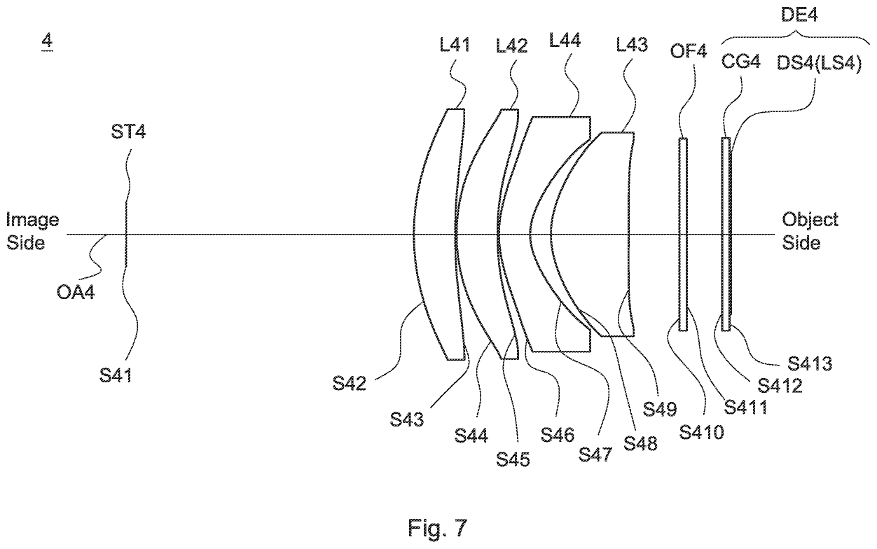

Referring to FIG. 7, the lens assembly 4 includes a stop ST4, a first lens L41, a second lens L42, a fourth lens L44, a third lens L43, an optical filter OF4, and a display element DE4, all of which are arranged in order from an image side to an object side along a first optical axis OA4. The first lens L41, the second lens L42, the fourth lens L44, and the fourth lens L43 can move synchronously along the first optical axis OA4 for focusing. The interval from the object side surface S49 of the third lens L43 to the image side surface S410 of the optical filter OF4 ranges from 2.89 mm to 3.97 mm, when the first lens L41, the second lens L42, the fourth lens L44, and the fourth lens L43 can synchronously along the first optical axis OA4 for focusing. The display element DE4 includes a cover glass CG4 and a display source DS4, both of which are arranged in order from the image side to the object side along the first optical axis OA4. The display source DS4 coincides with the lighting surface LS4. When in use, the human eye is located at the stop ST4 and the image of the display source DS4 can be seen.

The first lens L41 is a meniscus lens with positive refractive power and made of glass material, wherein the image side surface S42 is a convex surface, the object side surface S43 is a concave surface, and both of the image side surface S42 and object side surface S43 are aspheric surfaces.

The second lens L42 is a meniscus lens with positive refractive power and made of glass material, wherein the image side surface S44 is a convex surface, the object side surface S45 is a concave surface, and both of the image side surface S44 and object side surface S45 are aspheric surfaces.

The fourth lens L44 is a meniscus lens with negative refractive power and made of glass material, wherein the image side surface S46 is a convex surface, the object side surface S47 is a concave surface, and both of the image side surface S46 and object side surface S47 are aspheric surfaces.

The third lens L43 is a biconvex lens with positive refractive power and made of glass material, wherein the image side surface S48 is a convex surface, the object side surface S49 is a convex surface, and both of the image side surface S48 and object side surface S49 are aspheric surfaces.

Both of the image side surface S410 and object side surface S411 of the optical filter OF4 are plane surfaces.

Both of the image side surface S412 and object side surface S413 of the cover glass CG4 are plane surfaces.

With the above design of the lenses, stop ST4, and at least one of the conditions (1)-(5) satisfied, the lens assembly 4 can have an effective increased field of view, an effective increased resolution, an effective corrected aberration, and an effective corrected chromatic aberration.

Table 10 shows the optical specification of the lens assembly 4 in FIG. 7.

TABLE 10
Effective Focal Length = 16 mm F-number = 4.03
Total Lens Length = 21.503 mm Field of View = 34.55 degrees

| Surface | Radius of | Thickness | | | Effective Focal | |
|---|---|---|---|---|---|---|
| Number | Curvature (mm) | (mm) | Nd | Vd | Length (mm) | Remark |
| S41 | ∞ | 19.50 | | | | ST4 |
| S42 | 13.45 | 2.80 | 1.535 | 56.115 | 40.73 | L41 |
| S43 | 32.56 | 0.10 | | | | |
| S44 | 10.51 | 2.77 | 1.535 | 56.115 | 48.08 | L42 |
| S45 | 16.13 | 0.10 | | | | |
| S46 | 6.35 | 2.11 | 1.661 | 20.382 | −12.33 | L44 |
| S47 | 3.10 | 1.41 | | | | |
| S48 | 5.05 | 5.27 | 1.535 | 56.115 | 9.24 | L43 |
| S49 | −159.14 | 3.44 | | | | |
| S410 | ∞ | 0.50 | 1.5168 | 64.1673 | | OF4 |
| S411 | ∞ | 2.40 | | | | |
| S412 | ∞ | 0.50 | 1.5168 | 64.1673 | | CG4 |
| S413 | ∞ | 0.10 | | | | |

The aspheric surface sag z of each aspheric lens in table 10 can be calculated by the following formula:

z=ch²/{1+[1−(k+1)c²h²]^{1/2}}+Ah⁴+Bh⁶+Ch⁸+Dh¹⁰+Eh¹²+Fh¹⁴

where c is curvature, h is the vertical distance from the lens surface to the optical axis, k is conic constant and A, B, C, D, E, and F are aspheric coefficients.

In the fourth embodiment, the conic constant k and the aspheric coefficients A, B, C, D, E, F of each aspheric lens are shown in Table 11.

TABLE 11

| Surface | | A | B | | |
|---|---|---|---|---|---|
| Number | k | E | F | C | D |
| S42 | −5.9235E+00 | 3.2063E−04 | −3.1846E−06 | −6.6204E−09 | −4.2586E−11 |
| | | 1.5061E−11 | −1.7739E−13 | | |
| S43 | 1.2791E+01 | 1.5716E−04 | −1.1769E−05 | 1.2042E−07 | 8.4075E−10 |
| | | −1.9694E−11 | 1.6269E−14 | | |
| S44 | −2.3635E−02 | 2.0999E−04 | −6.6118E−06 | 1.2901E−08 | 1.5802E−09 |
| | | −2.4594E−11 | 2.0805E−14 | | |
| S45 | −5.4052E+00 | 5.7950E−04 | −2.0602E−05 | 2.7086E−07 | −8.3088E−10 |
| | | −2.3931E−11 | 1.6133E−13 | | |
| S46 | −1.9159E+00 | −9.9143E−04 | 1.2752E−05 | 5.6221E−08 | −2.1483E−09 |
| | | 1.1011E−11 | −3.3730E−15 | | |
| S47 | −1.7742E+00 | −1.2208E−03 | 6.3865E−05 | −9.4927E−07 | 1.3586E−09 |
| | | 2.9905E−10 | −3.6900E−12 | | |
| S48 | −9.1602E−01 | −1.3423E−03 | 3.6083E−05 | −4.8423E−07 | 8.2958E−09 |
| | | −2.3197E−10 | 2.8636E−12 | | |
| S49 | 5.7160E+01 | 3.3548E−04 | −4.0819E−06 | 4.1287E−07 | −6.0446E−09 |
| | | −1.4639E−10 | 2.8985E−12 | | |

Table 12 shows the parameters and condition values for conditions (1)-(5) in accordance with the fourth embodiment of the invention. It can be seen from Table 12 that the lens assembly 4 of the fourth embodiment satisfies the conditions (1)-(5).

TABLE 12

| | | | | | |
|---|---|---|---|---|---|
| BFL | 6.34 mm | | | | |
| f/TTL | 0.74 | (f + BFL)/TTL | 1.04 | (f − BFL)/TTL | 0.45 |
| (TTL + | 1.74 | (TTL − BFL)/f | 0.95 | | |
| BFL)/f | | | | | |

In the above embodiments, the lens assemblies include 4 lenses, but it can be understood that a lens group can also be added and the lens group is arranged along a second optical axis, wherein the first optical axis and the second optical axis are not coaxial, and falls into the scope of the invention.

In the above embodiments, the lens assemblies can also be added an image sensor element and the image sensor element is arranged along a second optical axis, wherein the first optical axis and the second optical axis are not coaxial, and falls into the scope of the invention.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is with positive refractive power and comprises a convex surface facing an image side;
a second lens which is a meniscus lens with refractive power;
a third lens which is with positive refractive power and comprises a convex surface facing the image side; and
a cover glass;
wherein the first lens, the second lens, the third lens, and the cover glass are arranged in order from the image side to an object side along a first optical axis;
wherein the lens assembly satisfies at least one of following conditions:
0.6<f/TTL<0.8;
0.85<(f+BFL)/TTL<1.2;
0.36<(f−BFL)/TTL<0.55;
1.6<(TTL+BFL)/f<1.95;
0.5<(TTL−BFL)/f<1.15;
wherein f is an effective focal length of the lens assembly, TTL is an interval from an image side surface of the first lens to a lighting surface along the first optical axis, and BFL is an interval from an object side surface of the lens closest to the object side to an image side surface of the cover glass along the first optical axis.

2. The lens assembly as claimed in claim 1, further comprising a fourth lens, wherein the fourth lens is with negative refractive power and comprises a concave surface facing the object side.

3. The lens assembly as claimed in claim 2, wherein the fourth lens is disposed between the third lens and the cover glass.

4. The lens assembly as claimed in claim 3, wherein the first lens is a biconvex lens and further comprises another convex surface facing the object side.

5. The lens assembly as claimed in claim 4, wherein:
the second lens is with negative refractive power and comprises a concave surface facing the image side and a convex surface facing the object side;
the third lens is a biconvex lens and further comprises another convex surface facing the object side; and
the fourth lens is a biconcave lens and further comprises another concave surface facing the image side.

6. The lens assembly as claimed in claim 4, wherein:
the second lens further comprises a convex surface facing the image side and a concave surface facing the object side;
the third lens is a meniscus lens and further comprises a concave surface facing the object side; and
the fourth lens is a meniscus lens and further comprises a convex surface facing the image side.

7. The lens assembly as claimed in claim 3, wherein:
the third lens and the fourth lens are cemented;
the first lens is a single lens instead of a cemented lens;
the second lens is a single lens instead of a cemented lens; and
an interval is disposed between the first lens and the second lens.

8. The lens assembly as claimed in claim 2, wherein:
the fourth lens further comprises an image side surface facing the image side, wherein the image side surface does not comprise an inflection point; and
the concave surface of the fourth lens does not comprise an inflection point.

9. The lens assembly as claimed in claim 3, wherein the first lens and the second lens can move synchronously along the first optical axis for focusing.

10. The lens assembly as claimed in claim 3, further comprising a lens group, wherein the lens group is arranged along a second optical axis, and the first optical axis and the second optical axis are not coaxial.

11. The lens assembly as claimed in claim 3, further comprising an image sensor element, wherein the image sensor element is arranged along a second optical axis, and the first optical axis and the second optical axis are not coaxial.

12. The lens assembly as claimed in claim 3, further comprising a display source disposed between the cover glass and the object side, wherein:
the position of the display source overlaps with the lighting surface; and
the cover glass and the display source are arranged in order from the image side to the object side along the first optical axis.

13. The lens assembly as claimed in claim 2, wherein the fourth lens is disposed between the second lens and the third lens.

14. The lens assembly as claimed in claim 13, wherein the first lens is a meniscus lens and further comprises a concave surface facing the object side.

15. The lens assembly as claimed in claim 14, wherein:
the second lens is with positive refractive power and comprises a convex surface facing the image side and a concave surface facing the object side;
the fourth lens is a meniscus lens and further comprises a convex surface facing the image side; and
the third lens is a biconvex lens and further comprises another convex surface facing the object side.

16. The lens assembly as claimed in claim 13, wherein:
the first lens is a single lens instead of a cemented lens;
the second lens is a single lens instead of a cemented lens; and
an interval is disposed between the first lens and the second lens.

17. The lens assembly as claimed in claim 14, wherein:
the convex surface of the third lens does not comprise an inflection point; and
the another convex surface of the third lens does not comprise an inflection point.

18. The lens assembly as claimed in claim 13, wherein the first lens and the second lens can move along the first optical axis for focusing.

19. The lens assembly as claimed in claim 13, further comprising a display source disposed between the cover glass and the object side, wherein:
the position of the display source overlaps with the lighting surface; and
the cover glass and the display source are arranged in order from the image side to the object side along the first optical axis.

20. The lens assembly as claimed in claim 13, wherein the first lens, the second lens, the third lens, and the fourth lens can move synchronously along the optical axis for focusing.
